(19) United States
(12) Patent Application Publication
(10) Pub. No.: US 2024/0036880 A1
(43) Pub. Date: Feb. 1, 2024

(54) INFORMATION PROCESSING APPARATUS AND CONTROL METHOD

(71) Applicant: Lenovo (Singapore) Pte. Ltd., Singapore (SG)

(72) Inventors: Masashi Nishio, Kanagawa (JP); Kazuhiro Kosugi, Kanagawa (JP)

(73) Assignee: Lenovo (Singapore) Pte. Ltd., Singapore (SG)

(21) Appl. No.: 18/347,570

(22) Filed: Jul. 6, 2023

(30) Foreign Application Priority Data
Jul. 26, 2022 (JP) 2022-118543

(51) Int. Cl. G06F 9/4401; G06V 40/16; G06F 1/16

(52) U.S. Cl. CPC G06F 9/4406; G06V 40/161; G06F 1/1652

(57) ABSTRACT

An information processing apparatus includes a foldable display; a camera which captures a direction to face at least part of the display surface; a sensor for detecting the posture of the information processing apparatus; a first processor which controls the operation of the system; a second processor which detects a face area from an image captured by the camera; and a third processor which processes while switching, based on the posture, between first processing to output first information when the face area is detected by the second processor, or output second information when the face area is not detected, and second processing to output either one of the first information and the second information regardless of the detection of the face area by the second processor. The operation of the system is controlled based on the first processing and the second processing.

### CROSS-REFERENCE TO RELATED APPLICATIONS

This application claims priority to Japanese Patent Application No. 2022-118543 filed on Jul. 26, 2022, the contents of which are hereby incorporated herein by reference in their entirety.

### BACKGROUND OF THE INVENTION

### Field of the Invention

The present invention relates to an information processing apparatus and a control method.

### Description of the Related Art

There is an apparatus which makes a transition to a usable operating state when a person approaches or to a standby state in which functions except some of the functions are stopped when the person leaves. For example, in Japanese Unexamined Patent Application Publication No. 2016-148895, there is disclosed a technique for detecting the intensity of infrared light using an infrared sensor to detect whether a person is approaching or a person has left in order to control the operating state of the apparatus.

In recent years, with the development of computer vision and the like, detection accuracy when detecting a face from an image has been getting higher. Therefore, face detection is beginning to be used instead of person detection using the infrared sensor. Infrared light is reflected back regardless of whether it is a person or an object other than the person when using the infrared sensor, but the use of face detection can suppress just an object from being detected as a person by mistake. For example, a PC (Personal Computer) or the like is equipped with a camera to capture an image for face detection described above in a position capable of capturing an image of the side where a user is present.

However, usage forms upon using a PC are diversified. For example, a laptop PC equipped with a foldable, flexible display may be used as a normal laptop PC by folding the display to some extent, or may be used like a tablet PC in a flat state without folding the display. Further, the laptop PC may be used with the display in landscape orientation, or may be used with the display in portrait orientation. Since the camera for capturing an image for face detection is provided on the display surface side so that the side on which the user is present can be captured, face detection may not be able to be performed correctly with the camera depending on the posture of the PC as the usage forms upon using the PC are diversified as described above. Therefore, there is concern that the operating state is controlled as the absence of a user even though the user is present, or that the operating state is controlled as the presence of the user even though the user is not present.

### SUMMARY OF THE INVENTION

One or more embodiments of the present invention provide an information processing apparatus and a control method capable of suppressing malfunction by false detection when controlling the operating state using face detection.

An information processing apparatus according to the first aspect of the present invention includes: a foldable display; an imaging unit which captures a direction to face at least part of a display surface of the display; a sensor for detecting the posture of the own information processing apparatus; a memory which temporarily stores a program of a system; a first processor which executes the program to control the operation of the system; a second processor which detects a face area with a face captured therein from an image captured by the imaging unit; and a third processor which executes processing while switching, based on the posture detected using the sensor, between first processing to output first information when the face area is detected by the second processor, or output second information when the face area is not detected, and second processing to output either one of the first information and the second information regardless of the detection of the face area by the second processor, wherein the first processor controls the operation of the system based on the first processing and the second processing switched therebetween and executed by the third processor.

Further, an information processing apparatus according to the second aspect of the present invention includes: a foldable display; an imaging unit which captures a direction to face at least part of a display surface of the display; a sensor for detecting the posture of the own information processing apparatus; a memory which temporarily stores a program of a system; a first processor which executes the program to control the operation of the system; a second processor which detects a face area with a face captured therein from an image captured by the imaging unit; and a third processor which executes processing while switching, based on the posture detected using the sensor, between first processing to output first information when the face area is detected by the second processor, or output second information when the face area is not detected, and second processing to output the second information regardless of the detection of the face area by the second processor, wherein the first processor controls the operation of the system based on the first processing and the second processing switched therebetween and executed by the third processor.

The above information processing apparatus may also be such that the first processor executes the program to switch between a first operating state in which the system is booted and working, and a second operating state in which at least part of the operation of the system is limited compared to the first operating state, and when executing the second processing, the third processor outputs the second information regardless of the detection of the face area by the second processor in the second operating state.

The above information processing apparatus may also be such that the first processor executes the program to switch between a first operating state in which the system is booted and working, and a second operating state in which at least part of the operation of the system is limited compared to the first operating state, and when executing the second processing, the third processor outputs the first information regardless of the detection of the face area by the second processor in the first operating state, and outputs the second information regardless of the detection of the face area by the second processor in the second operating state.

The above information processing apparatus may further be such that, in the first operating state, the first processor makes a transition to the second operating state under a condition that there is no operation input by a user for a certain period of time, and when the second information output from the third processor is acquired, the first processor makes the transition to the second operating state without waiting for the certain amount of time.

Further, the above information processing apparatus may be such that, when the first information output from the third processor is acquired in the second operating state, the first processor makes a transition to the first operating state, and while acquiring the second information output from the third processor, the first processor maintains the second operating state.

Further, the above information processing apparatus may be such that the second processor detects, as the face area, a face area of a face facing forward from an image captured by the imaging unit.

Further, the above information processing apparatus may be such that the third processor detects the posture using the sensor based on a folding angle of the display.

Further, the above information processing apparatus may be such that the third processor detects the posture using the sensor based on a rotation angle using an axis orthogonal to the display surface of the display as an axis of rotation.

Further, the above information processing apparatus may be such that the third processor detects the posture using the sensor based on an angle of the display surface of the display with respect to a horizontal plane.

Further, a control method according to the third aspect of the present invention is a control method for an information processing apparatus including: a foldable display; an imaging unit which captures a direction to face at least part of the display surface of the display; a sensor for detecting the posture of the own information processing apparatus; a memory which temporarily stores a program of a system; a first processor; a second processor; and a third processor, the control method including: a step of causing the first processor to execute the program in order to control the operation of the system; a step of causing the second processor to detect a face area with a face captured therein from an image captured by the imaging unit; and a step of causing the third processor to execute processing while switching, based on the posture detected using the sensor, between first processing to output first information when the face area is detected by the second processor, or output second information when the face area is not detected, and second processing to output either one of the first information and the second information regardless of the detection of the face area by the second processor, wherein when controlling the operation of the system, the first processor controls the operation of the system based on the first processing and the second processing switched therebetween and executed by the third processor.

Further, a control method according to the fourth aspect of the present invention is a control method for an information processing apparatus including: a foldable display; an imaging unit which captures a direction to face at least part of the display surface of the display; a sensor for detecting the posture of the own information processing apparatus; a memory which temporarily stores a program of a system; a first processor; a second processor; and a third processor, the control method including: a step of causing the first processor to execute the program in order to control the operation of the system; a step of causing the second processor to detect a face area with a face captured therein from an image captured by the imaging unit; and a step of causing the third processor to execute processing while switching, based on the posture detected using the sensor, between first processing to output first information when the face area is detected by the second processor, or output second information when the face area is not detected, and second processing to output the second information regardless of the detection of the face area by the second processor, wherein when controlling the operation of the system, the first processor controls the operation of the system based on the first processing and the second processing switched therebetween and executed by the third processor.

The above-described aspects of the present invention can cause the information processing apparatus to suppress malfunction by false detection when controlling the operating state using face detection.

### BRIEF DESCRIPTION OF THE DRAWINGS

FIG. 1 is a perspective view illustrating a configuration example of the appearance of an information processing apparatus according to one or more embodiment.

FIG. 2 is a side view illustrating an example of the information processing apparatus in a bent state according to one or more embodiments.

FIG. 3 is a side view illustrating an example of the information processing apparatus in a flat state according to one or more embodiments.

FIGS. 4A-4C are diagrams for describing an outline of HPD processing of the information processing apparatus according to one or more embodiments.

FIG. 5 is a diagram illustrating an example of a person detection range of the information processing apparatus according to one or more embodiments.

FIG. 6 is a diagram illustrating specific examples of various display modes in various usage forms of the information processing apparatus according to one or more embodiments.

FIG. 7 is a diagram illustrating examples of usage forms with the HPD processing supported and usage forms with the HPD processing unsupported according to one or more embodiments.

FIG. 8 is a schematic block diagram illustrating an example of the hardware configuration of the information processing apparatus according to one or more embodiments.

FIG. 9 is a schematic block diagram illustrating an example of the functional configuration of the information processing apparatus according to one or more embodiments.

FIG. 10 is a flowchart illustrating an example of HPD control processing in a normal operating state according to one or more embodiments.

FIG. 11 is a flowchart illustrating an example of sleep processing according to one or more embodiments.

FIG. 12 is a flowchart illustrating an example of HPD control processing in a standby state according to one or more embodiments.

FIG. 13 is a flowchart illustrating an example of boot processing according to one or more embodiments.

### DETAILED DESCRIPTION OF THE INVENTION

One or more embodiments of the present invention will be described below with reference to the accompanying drawings.

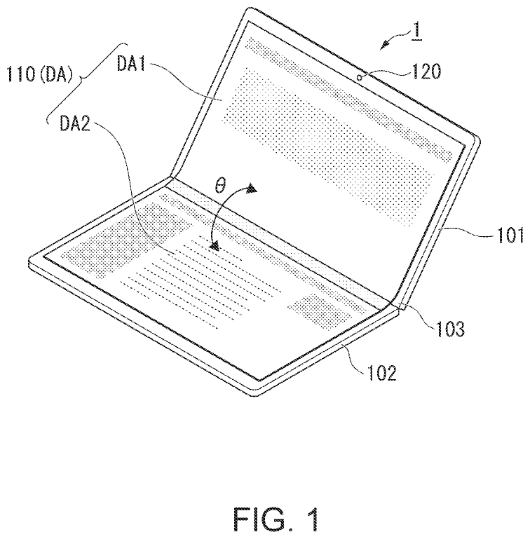

FIG. 1 is a perspective view illustrating the appearance of an information processing apparatus 1 according to one or more embodiments. The information processing apparatus 1 according to one or more embodiments is, for example, a laptop PC (Personal Computer) equipped with a foldable display. The information processing apparatus 1 includes a first chassis 101, a second chassis 102, and a hinge mechanism 103. The first chassis 101 and the second chassis 102 are chassis having a substantially rectangular plate shape (for example, a flat plate shape). One of the sides of the first chassis 101 and one of the sides of the second chassis 102 are joined (coupled) through the hinge mechanism 103 in such a manner that the first chassis 101 and the second chassis 102 are rotatable relative to each other around the rotation axis of the hinge mechanism 103.

A state where a hinge angle θ between the first chassis 101 and the second chassis 102 around the rotation axis is substantially 0° is a state where the first chassis 101 and the second chassis 102 are closed in such a manner as to overlap each other (closed state). Surfaces of the first chassis 101 and the second chassis 102 on the sides to face each other in the closed state are called “inner surfaces,” and surfaces on the other sides of the inner surfaces are called “outer surfaces,” respectively. The hinge angle θ can also be called an angle between the inner surface of the first chassis 101 and the inner surface of the second chassis 102. As opposed to the closed state, a state where the first chassis 101 and the second chassis 102 are open is called an “open state.” The open state is a state where the first chassis 101 and the second chassis 102 are rotated relative to each other until the hinge angle θ exceeds a preset threshold value (for example, 10°). The inner surface of the first chassis 101 and the inner surface of the second chassis 102 are flattened out (flat state) when the hinge angle θ is 180°. The example illustrated in FIG. 1 corresponds to a typical usage form of a so-called clamshell PC in a state where the hinge angle θ is about 70° to 135°.

Further, the information processing apparatus 1 includes a display 110 (display unit) and an imaging unit 120. The display 110 is provided from the inner surface of the first chassis 101 to the inner surface of the second chassis 102. The display 110 is a flexible display bendable (foldable) to fit the hinge angle θ by relative rotation of the first chassis 101 and the second chassis 102. As the flexible display, an organic EL display or the like is used.

The information processing apparatus 1 can control not only display as a one-screen structure in the entire screen area of the display 110 as one screen area DA, but also display as a two-screen structure by splitting the entire screen area of the display 110 into two screen areas of a first screen area DA1 and a second screen area DA2. Here, since the first screen area DA1 and the second screen area DA2 are screen areas as a result of splitting the screen area DA of the display 110, they are screen areas that do not overlap each other. Here, it is assumed that a screen area corresponding to the inner surface side of the first chassis 101 in the screen areas of the display 110 is the first screen area DA1, and a screen area corresponding to the inner surface side of the second chassis 102 is the second screen area DA2. In the following, a display mode to control the display in the one-screen structure is called a “one-screen mode,” and a display mode to control the display in the two-screen structure is called a “two-screen mode.”

Further, for example, the display 110 is configured together with a touch panel to accept user's operations on the display screen of the display 110. A user can view the display of the display 110 provided on the respective inner surfaces of the first chassis 101 and the second chassis 102 and perform touch operations on the display 110 by putting the information processing apparatus 1 into the open state, thus enabling the use of the information processing apparatus 1.

The imaging unit 120 is provided outside (in a peripheral area) of the screen area DA of the display 110 on the inner surface of the first chassis 101. For example, the imaging unit 120 is placed on the first chassis 101 near the center of a side opposite to the side of the first chassis 101 joined (coupled) to the second chassis 102 through the hinge mechanism 103.

This position at which the imaging unit 120 is placed corresponds to the “12 o'clock position” of an analog clock by replacing the center position of the information processing apparatus 1 with the center position of the analog clock when viewing the information processing apparatus 1 from the user, which is referred to as an “upper-side position” below. The “6 o'clock position” opposite to this upper-side position is referred to as the “lower-side position,” the “9 o'clock position” is referred to as the “left-side position,” and the “3 o'clock position” is referred to as the “right-side position.”

In the open state, the imaging unit 120 captures a predetermined imaging range in a direction (frontward) to face the first chassis 101. The predetermined imaging range is a range of angle of view defined by an image sensor included in the imaging unit 120 and an optical lens provided in front of an imaging surface of the image sensor. For example, the imaging unit 120 can capture an image including a person present in front of the information processing apparatus 1.

Note that the position at which the imaging unit 120 is placed as illustrated in FIG. 1 is just an example, and the imaging unit 120 may also be placed at any other position capable of capturing an image in the direction (frontward) to face the display 110.

Usage forms of the information processing apparatus 1 are classified into a state in which the first chassis 101 and the second chassis 102 are bent at the hinge angle θ between the first chassis 101 and the second chassis 102 (Bent form), and a flat state in which the first chassis 101 and the second chassis 102 are not bent (Flat form). In the following, the state where the first chassis 101 and the second chassis 102 are bent (Bent form) is simply called “bent state (Bent form),” and the flat state where the first chassis 101 and the second chassis 102 are not bent (Flat form) is simply called “flat state (Flat form).” In the bent state (Bent form), the display 110 provided over the first chassis 101 and the second chassis 102 is also in the bent state. In the flat state (Flat form), the display 110 is also in the flat state.

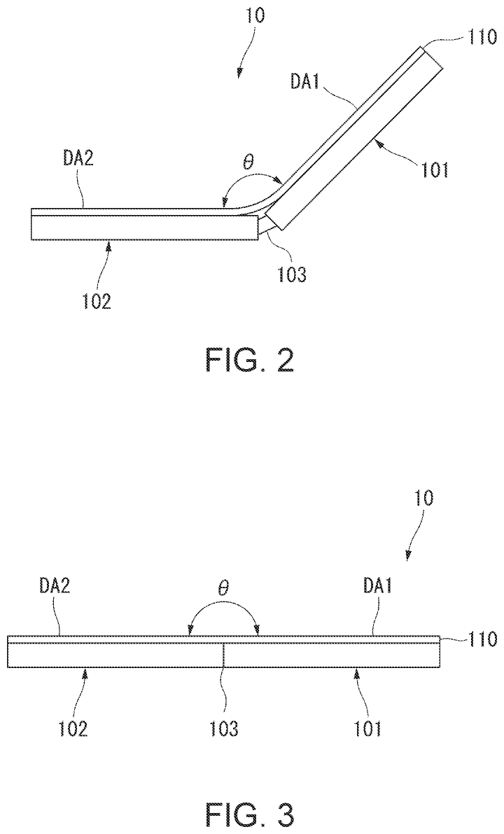

FIG. 2 is a side view illustrating an example of the information processing apparatus 1 in the bent state (Bent form). The display 110 is placed over (across) the first chassis 101 and the second chassis 102. The screen area of the display 110 (the screen area DA illustrated in FIG. 1) can be bent by using a part corresponding to the hinge mechanism 103 as a crease, and on the border of this crease, a screen area on the side of the first chassis 101 is illustrated as the first screen area DA1, and a screen area on the side of the second chassis 102 is illustrated as the second screen area DA2. The display 110 is bent according to the rotation (hinge angle θ) between the first chassis 101 and the second chassis 102. The information processing apparatus 1 determines whether or not the state is the bent state (Bent form) depending on the hinge angle θ. As an example, in the case of 10°<θ<170°, the information processing apparatus 1 determines the bent state (Bent form).

This state corresponds to a usage form as a so-called clamshell mode or a book mode.

FIG. 3 is a side view illustrating an example of the information processing device 1 in the flat state (Flat form). The information processing apparatus 1 typically determines the flat state (Flat form) when the hinge angle θ is 180°, but as an example, the information processing apparatus 1 may also determine the flat state (Flat form) when the hinge angle θ is in a range of 170°≤θ≤180°. For example, when the hinge angle θ between the first chassis 101 and the second chassis 102 is 180°, the display 110 is also in the flat state. This state corresponds to a usage form as a so-called tablet mode.

[Outline of HPD Processing]

Based on an image captured by the imaging unit 120, the information processing apparatus 1 detects a person (that is, a user) present in the neighborhood of the information processing apparatus 1. This processing for detecting the presence of the person is called HPD (Human Presence Detection) processing. The information processing apparatus 1 detects the presence or absence of a person by the HPD processing to control the operating state of the system of the information processing apparatus 1 based on the detection result.

The information processing apparatus 1 can make a transition at least between a normal operating state (power-on state) and a standby state as system operating states. The normal operating state is an operating state capable of executing processing without being particularly limited, which corresponds, for example, to S0 state defined in the ACPI (Advanced Configuration and Power Interface) specification. The standby state is an operating state in which at least some of functions of the system are limited. For example, the standby state may be the standby state or a sleep state, or a state corresponding to modern standby in Windows (registered trademark) or S3 state (sleep state) defined in the ACPI specification. Further, a state in which at least the display of the display unit appears to be Off (screen OFF) or a screen lock state may also be included as the standby state. The screen lock is a state in which an image preset to make a processed content invisible (for example, an image for the screen lock) is displayed on the display unit, that is, an unusable state until the lock is released (for example, until the user is authenticated).

In the following, a transition of the system operating state from the standby state to the normal operating state may be called “boot.” In the standby state, since the activation level is generally lower than the normal operating state, the boot of the system of the information processing apparatus 1 leads to the activation of the operation of the system in the information processing apparatus 1.

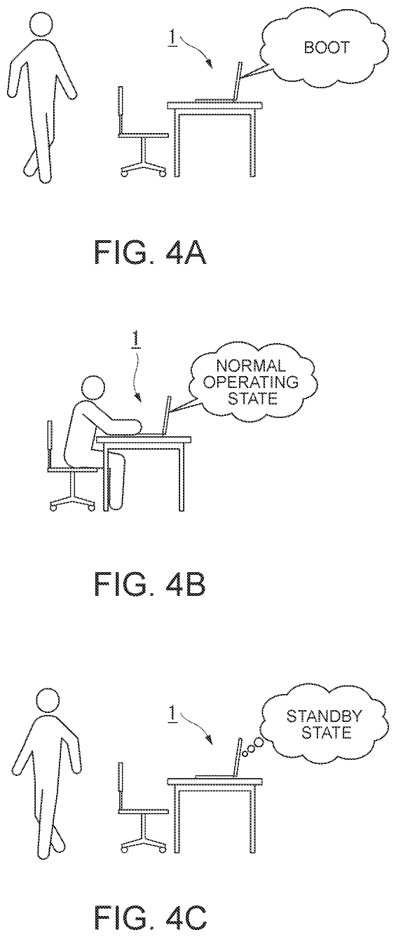

FIGS. 4A-4C are diagrams for describing an outline of HPD processing of the information processing apparatus 1 according to one or more embodiments. For example, as illustrated in FIG. 4A, when detecting a change from a state where no person is present in front of the information processing apparatus 1 (Absence) to a state where a person is present (Presence), that is, when detecting that a person approaches the information processing apparatus 1 (Approach), the information processing apparatus 1 determines that a user has approached and automatically boots the system to make a transition to the normal operating state. Further, in a state where a person is present in front of the information processing apparatus 1 (Presence) as illustrated in FIG. 4B, the information processing apparatus 1 determines that the user is present and continues the normal operating state. Then, as illustrated in FIG. 4C, when detecting a change from the state where the person is present in front of the information processing apparatus 1 (Presence) to the state where the person is no longer present (Absence), that is, when detecting that the person has left the information processing apparatus 1 (Leave), the information processing apparatus 1 determines that the user has left and causes the system to make a transition to the standby state.

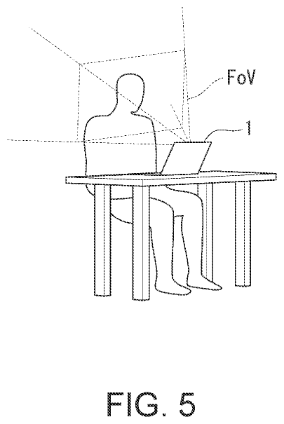

FIG. 5 is a diagram illustrating an example of a person detection range of the information processing apparatus 1 according to one or more embodiments. In the illustrated example, a detection range FoV (Field of View: detection viewing angle) in front of the information processing apparatus 1 is a person-detectable range. For example, the information processing apparatus 1 detects a face area with a face captured therein from a captured image captured forward by the imaging unit 120 to determine whether or not a person (user) is present in front of the information processing apparatus 1. The detection range FoV corresponds to an imaging angle of view at which the imaging unit 120 captures the image. Based on the fact that the face area is detected from the captured image, the information processing apparatus 1 determines that the user is present. On the other hand, based on the fact that no face area is detected from the captured image, the information processing apparatus 1 determines that the user is not present.

Here, when the posture of the information processing apparatus 1 changes depending on the usage form upon using the information processing apparatus 1, the position of the imaging unit 120 also changes to change the detection range FoV. In this case, any face area may not be detected from a captured image even though the user is present. The posture of the information processing apparatus 1 indicates the orientation of the information processing apparatus 1, whether the information processing apparatus 1 is in the bent state (Bent form) or the “flat state (Flat form),” and the like.

[Examples of Usage Forms]

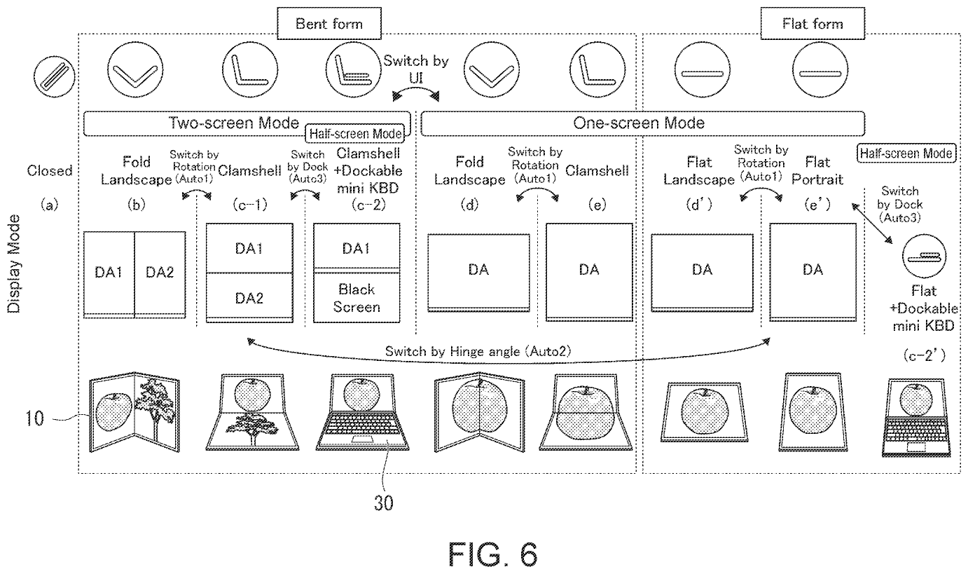

Referring here to FIG. 6, various usage forms of the information processing apparatus 1 will be described.

FIG. 6 is a diagram illustrating specific examples of display modes in various usage forms of the information processing apparatus 1 according to one or more embodiments. The display mode of the information processing apparatus 1 is changed depending on the usage form. For example, the display mode of the information processing apparatus 1 varies depending on the usage form classified by the posture of the information processing apparatus 1 such as by the orientation of the information processing apparatus 1 and the hinge angle θ, whether the display mode is the one-screen mode or the two-screen mode, and the like. Note that one screen is also called a single screen or a full screen, and two screens are also called split screens or dual screens.

Display mode (a) is a display mode when the first chassis 101 and the second chassis 102 are in the closed state (Closed) as the usage form. For example, in this closed state, the information processing apparatus 1 is in a standby state such as a sleep state or a hibernation state, and the display 110 is in a display-off state. This standby state such as the sleep state or the hibernation state corresponds, for example, to S3 or S4 as system power status defined in the ACPI (Advanced Configuration and Power Interface) specification.

Display mode (b) is a display mode when the first chassis 101 and the second chassis 102 are in the bent state (Bent form) as the usage form and in the two-screen mode in which the display is controlled by splitting the screen area of the display 110 into the two screen areas of the first screen area DA1 and the second screen area DA2. Further, the orientation of the information processing apparatus 1 is an orientation in which the first screen area DA1 and the second screen area DA2 are lined up side by side in portrait orientation. The portrait orientation of the screen areas means an orientation in which long sides of the four sides of each of rectangular screen areas are vertical and short sides are horizontal. When the display areas are in portrait orientation, the display orientation is also portrait, that is, the display is provided in such an orientation that the direction along the long sides corresponds to the up-down direction and the direction along the short sides corresponds to the left-right direction. This usage form is a usage form in which left and right pages when the user takes a book in user's hand and opens the book correspond to left and right screens, which corresponds to the so-called book mode. Since this usage form is in the bent state (Bent form) and the screen area of two combined screen areas of the first screen area DA1 and the second screen area DA2 lined up side by side is horizontally long, it is also called “Fold Landscape.”

Like the display mode (b), display mode (c-1) is a display mode in the bent state (Bent form) and in the two-screen mode in which the display is controlled by splitting the screen area of the display 110 into the two screen areas of the first screen area DA1 and the second screen area DA2, but the display mode (c-1) is a usage form different from the display mode (b) in terms of the orientation of the information processing apparatus 1. The orientation of the information processing apparatus 1 is an orientation in which the first screen area DA1 and the second screen area DA2 are lined up and down in landscape orientation. The landscape orientation of the screen areas means an orientation in which long sides of the four sides of each of the rectangular screen areas are horizontal and short sides are vertical. When the screen areas are in landscape orientation, the display orientation is also landscape, that is, the display is provided in such an orientation that the direction along the short sides corresponds to the up-down direction and the direction along the long sides corresponds to the left-right direction. This usage form is one of typical usage forms of a clamshell PC as illustrated in FIG. 1.

For example, the information processing apparatus 1 detects a change in the posture (orientation) of the information processing apparatus 1 to automatically switch from the display mode (b) to the display mode (c-1) or from the display mode (c-1) to the display mode (b) (Switch by Rotation). For example, since the display mode (c-1) is in such a state that the display 110 is rotated 90 degrees in the right direction from the state of the display mode (b) in FIG. 6, the information processing apparatus 1 switches to the display mode (c-1) when detecting the rotation of a predetermined angle (for example, 45 degrees) or more in the right direction from the state of the display mode (b). Further, since the display mode (b) is in such a state that the display 110 is rotated 90 degrees in the left direction from the state of the display mode (c-1) in FIG. 6, the information processing apparatus 1 switches to the display mode (b) when detecting the rotation of a predetermined angle (for example, 45 degrees) or more in the left direction from the state of the display mode (c-1).

Like the display mode (c-1), display mode (c-2) is in the bent state (Bent form) with the same orientation of the information processing apparatus 1 but different in that an external keyboard 30 (Dockable mini KBD (KeyBord)) that can be mounted on the information processing apparatus 1 is placed in a predetermined position. This usage form is in such a state that a physical keyboard 30 is connected in a general usage form of the clamshell PC. For example, in one or more embodiments, the size of the keyboard 30 is almost equivalent to the size of the second screen area DA2, and the keyboard 30 is configured to be mountable on the second screen area DA2. Note that the keyboard 30 may also be a keyboard having an area smaller than the second screen area DA2. As an example, magnets are provided inside (the edges of) the bottom of the keyboard 30, and when the keyboard 30 is mounted on the second screen area DA2, the magnets are attracted to bezel parts of the inner surface edges of the second chassis 102 and fixed. Thus, the usage form becomes a usage form similar to that of a conventional clamshell PC with a physical keyboard originally provided thereon. Further, the information processing apparatus 1 and the keyboard 30 are connected, for example, through Bluetooth (registered trademark). In this display mode (c-2), since the keyboard 30 makes the second screen area DA2 invisible, the information processing apparatus 1 controls the second screen area DA2 to black display or display off. In other words, this display mode (c-2) is a display mode in which only one screen area as a half-screen area of the screen areas of the display 110 is enabled to provide a display (hereinafter called a “half-screen mode”), that is, a one-screen mode in which only the first screen area DA1 is used. In other words, the half-screen mode is a display mode in which the display of part of the screen area (screen area DA) of the display 110 (that is, first screen area DA1) except for the screen area (second screen area DA2) on which the keyboard 30 is mounted is controlled as a screen area.

For example, when detecting the connection with the external keyboard in the state of the display mode (c-1), the information processing apparatus 1 automatically switches from the display mode (c-1) to the display mode (c-2) (Switch by Dock).

Like the display mode (b), display mode (d) is in the bent state (Bent form) with the same orientation of the information processing apparatus 1 but different in that the display mode (d) is the one-screen mode in which the display of the entire screen area of the display 110 is controlled as one screen area DA. This usage form is the one-screen mode different from the display mode (b). However, since the usage form is in the bent state (Bent form) and the screen area DA is horizontally long, it is also called “Fold Landscape.” The screen area DA is in landscape orientation and the display orientation is also landscape. Note that since the display mode (d) is the “Fold Landscape” like the display mode (b), the display mode (d) also corresponds to the so-called book mode.

Here, for example, switching between the one-screen mode and the two-screen mode in the bent state (Bent form) is performed with a user operation. For example, the information processing apparatus 1 displays an operator as a UI (User Interface) capable of switching between the one-screen mode and the two-screen mode somewhere on the screen to switch from the display mode (b) to the display mode (d) based on an operation to the operator (Switch by UI).

Like the display mode (c-1), display mode (e) is in the bent state (Bent form) with the same orientation of the information processing apparatus 1 but different in that the display mode (e) is the one-screen mode in which the display of the entire screen area of the display 110 is controlled as one screen area DA. This usage form is different from the display mode (c-1) in that the display mode (e) is the one-screen mode, but the usage form corresponds to the usage form of the clamshell PC from the bent state (Bent form) and the orientation of the information processing apparatus 1. The screen area DA is in portrait orientation and the display orientation is also portrait.

For example, the information processing apparatus 1 detects a change in the posture (orientation) of the information processing apparatus 1 to automatically switch from the display mode (d) to the display mode (e), or from the display mode (e) to the display mode (d) (Switch by Rotation). For example, since the display mode (e) is in such a state that the display 110 is rotated 90 degrees in the right direction from the state of the display mode (d) in FIG. 6, the information processing apparatus 1 switches to the display mode (e) when detecting the rotation of a predetermined angle (for example, 45 degrees) or more in the right direction from the state of the display mode (d). Further, since the display mode (d) is in such a state that the display 110 is rotated 90 degrees in the left direction from the state of the display mode (e) in FIG. 6, the information processing apparatus 1 switches to the display mode (d) when detecting the rotation of a predetermined angle (for example, 45 degrees) or more in the left direction from the state of the display mode (e).

Like the display mode (d), display mode (d′) is in the one-screen mode and the orientation of the information processing apparatus 1 is such an orientation that the display area DA is horizontally long, but different in that the information processing apparatus 1 is in the flat state (Flat form). The flat state (Flat form) is a state in which the hinge angle θ between the first chassis 101 and the second chassis 102 is substantially 180°. This usage form corresponds to the so-called tablet mode described with reference to FIG. 3. Since this usage form is in the flat state (Flat form) and the screen area DA is horizontally long, it is also called “Flat Landscape.” This display mode (d′) differs from the display mode (d) only in the hinge angle θ between the first chassis 101 and the second chassis 102. Like in the display mode (d), the screen area DA in the display mode (d′) is in landscape orientation and the display orientation is also landscape.

Like the display mode (e), display mode (e′) is in the one-screen mode and the orientation of the information processing apparatus 1 is such an orientation that the screen area DA is vertically long, but different in that the information processing apparatus 1 is in the flat state (Flat form). Since this usage form is in the flat state (Flat form) and the screen area DA is vertically long, it is also called “Flat Portrait.” This display mode (e′) differs from the display mode (e) only in the hinge angle θ between the first chassis 101 and the second chassis 102. Like in the display mode (e), the screen area DA is portrait orientation and the display orientation is also portrait.

For example, the information processing apparatus 1 detects a change in the posture (orientation) of the information processing apparatus 1 to automatically switch from the display mode (d′) to the display mode (e′), or from the display mode (e′) to the display mode (d′) (Switch by Rotation). For example, since the display mode (e′) is in such a state that the display 110 is rotated 90 degrees in the right direction from the state of the display mode (d′) in FIG. 6, the information processing apparatus 1 switches to the display mode (e′) when detecting the rotation of a predetermined angle (for example, 45 degrees) or more in the right direction from the state of the display mode (d′). Further, since the display mode (d′) is in such a state that the display 110 is rotated 90 degrees in the left direction from the state of the display mode (e′) in FIG. 6, the information processing apparatus 1 switches to the display mode (d′) when detecting the rotation of a predetermined angle (for example, 45 degrees) or more in the left direction from the state of the display mode (e′).

Note that in the display mode (d′) and the display mode (e′), it is also possible to switch to the two-screen mode while keeping the flat state (Flat form) by the user performing an operation on a display mode switching icon. For example, when switching to the two-screen mode from the state of the display mode (d′), the display state becomes similar to the display mode (b) in the flat state (Flat form). Further, when switching to the two-screen mode from the state of the display mode (e′), the display state becomes similar to the display mode (c-1) in the flat state (Flat form).

Further, when detecting the connection with the keyboard 30 in the state of the display mode (e′), the information processing apparatus 1 automatically switches from the display mode (e′) to display mode (c-2′) (Switch by Dock). The display mode (c-2′) is in the flat state (Flat form) but different from the display mode (c-2) only in the hinge angle θ between the first chassis 101 and the second chassis 102. In this display mode (c-2′), since the second screen area DA2 becomes invisible by the keyboard 30, the information processing apparatus 1 performs control to provide a black display or turn off the display. In other words, like the display mode (c-2), this display mode (c-2′) is a half-screen mode in which only one screen area as a half screen is enabled to provide a display in the screen area of the display 110.

Further, when detecting a change from the flat state (Flat form) to the bent state (Bent form), the information processing apparatus 1 can also switch from the one-screen mode to the two-screen mode. For example, when detecting a change to the bent state (Bent form) in the state of the display mode (d′) based on the hinge angle θ between the first chassis 101 and the second chassis 102, the information processing apparatus 1 automatically switches from the display mode (d′) to the display mode (b). Further, when detecting a change to the bent state (Bent form) in the state of the display mode (e′) based on the hinge angle θ between the first chassis 101 and the second chassis 102, the information processing apparatus 1 automatically switches from the display mode (e′) to the display mode (c-1).

Thus, the information processing apparatus 1 is used by the user in various usage forms. However, when the posture of the information processing apparatus 1 is changed depending on the usage form, the position of the imaging unit 120 is also changed to change the detection range FoV. When the detection range FoV is changed, since the information processing apparatus 1 may not be able to detect the face of the user correctly, there is a possibility that the operating state of the system cannot be controlled properly. Therefore, the information processing apparatus 1 switches whether or not to enable the control of the operating state of the system by the HPD processing depending on the posture of the information processing apparatus 1.

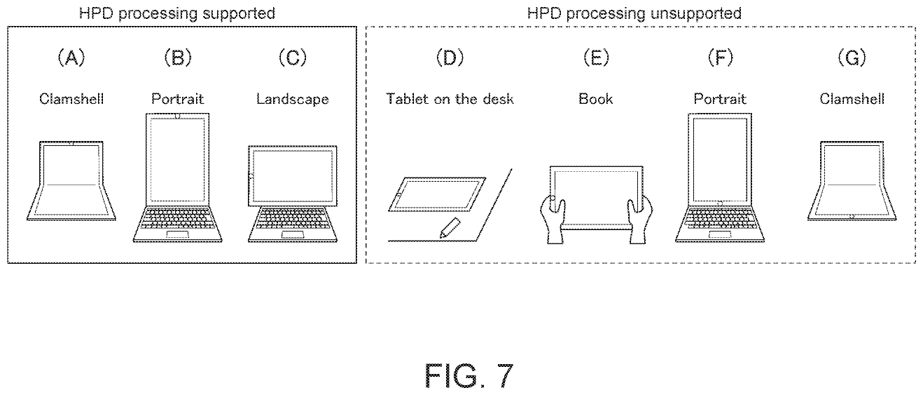

In the following, the fact that the control of the operating state of the system by the HPD processing is enabled is called “HPD processing supported.” On the other hand, the fact that the control of the operating state of the system by the HPD processing is disabled is called “HPD processing unsupported.” Referring to FIG. 7, examples of the postures (usage forms) of the information processing apparatus 1 with the HPD processing supported, and the postures (usage forms) of the information processing apparatus 1 with the HPD processing unsupported will be described.

FIG. 7 is a diagram illustrating examples of usage forms with the HPD processing supported and usage forms with the HPD processing unsupported according to one or more embodiments.

Three usage forms (A), (B), and (C) illustrated in FIG. 7 indicate examples of usage forms with the HPD processing supported. The usage form (A) is a typical usage form of the clamshell PC, which corresponds to the usage form of the display mode (c-1) or the display mode (e) in FIG. 6. The imaging unit 120 is placed near the center of the upper side as described with reference to FIG. 1. Therefore, as illustrated in FIG. 5, since the face of the user is likely to be present in the detection range FoV (that is, since the detection of the face of the user is possible), the information processing apparatus 1 enables the control of the operating state of the system by the HPD processing.

The usage form (B) is a usage form in which the orientation of the information processing apparatus 1 (screen area DA) is vertically long, which corresponds to the usage form of “Flat Portrait” of the display mode (e′) in FIG. 6. This usage form is simply called “Portrait” below. Like the usage form (A), the imaging unit 120 is placed near the center of the upper side. Therefore, since the detection of the face of the user is possible, the information processing apparatus 1 enables the control of the operating state of the system by the HPD processing.

The usage form (C) is a usage form in which the orientation of the information processing apparatus 1 (screen area DA) is horizontally long, which corresponds to the usage form of “Flat Landscape” of the display mode (d′) in FIG. 6. This usage form is simply called “Landscape” below. The imaging unit 120 is placed near the center of the left side, but the detection of the face of the user is possible. Therefore, the information processing apparatus 1 enables the control of the operating state of the system by the HPD processing.

On the other hand, four usage forms (D), (E), (F), and (G) indicate examples of usage forms with the HPD processing unsupported. The usage form (D) is Portrait or Landscape, but the information processing apparatus 1 is placed on a desk with the surface of the display 110 facing up. Since the imaging unit 120 is facing the ceiling, the face of the user is likely to deviate from the detection range FoV, and the face of the user may not be able to be detected. Therefore, the information processing apparatus 1 disables the control of the operating state of the system by the HPD processing.

The usage form (E) is the book mode, which corresponds to the usage form of the display mode (a) or the display mode (d) in FIG. 6. In the book mode, for example, although the imaging unit 120 is placed near the center of the left side as illustrated in FIG. 7, when the user holds the information processing apparatus 1 in hand, the imaging direction may be obstructed and hence the face of the user may not be able to be detected. Therefore, the information processing apparatus 1 disables the control of the operating state of the system by the HPD processing.

Like the usage form (B), the usage form (F) is “Portrait,” but different from the usage form (B) in that the orientation of the information processing apparatus 1 is upside down. The upside-down state is a state in which the information processing apparatus 1 is rotated by 180° using the axis orthogonal to the display surface of the display 110 as the axis of rotation (that is, rotated by 180° in a direction horizontal to the display surface of the display 110). Since the imaging unit 120 is placed in a position on the lower side, the face of the user is likely to deviate from the detection range FoV, and hence the face of the user may not be able to be detected. Therefore, the information processing apparatus 1 disables the control of the operating state of the system by the HPD processing.

Like the usage form (A), the usage form (G) is “Clamshell,” but different from the usage form (A) in the orientation of the information processing apparatus 1, that is, the relationship between the first chassis 101 and the second chassis 102 are opposite to that in the usage form (A). Since the imaging direction of the imaging unit 120 faces the direction of the ceiling, the face of the user is likely to deviate from the detection range FoV, and hence the face of the user may not be able to be detected. Therefore, the information processing apparatus 1 disables the control of the operating state of the system by the HPD processing.

Note that the usage forms with the HPD processing supported and the usage forms with the HPD processing unsupported illustrated in FIG. 7 are just examples, and the present invention is not limited to these examples. The information processing apparatus 1 detects the posture of the information processing apparatus 1 to determine whether or not the usage form is to support the HPD processing based on the detected posture.

For example, the posture of the information processing apparatus 1 is determined based on at least any one of the hinge angle θ, the angle of the display surface of the display 110 with respect to the horizontal plane (hereinafter called “display angle α”), and the rotation angle using the axis orthogonal to the display surface of the display 110 as the axis of rotation (hereinafter called “rotation angle β”).

For example, when the information processing apparatus 1 is placed on the desk with the surface of the display 110 facing up like in the usage form (D), the display angle α is 0°, when the information processing apparatus 1 is placed on the desk with the surface of the display 110 facing down, the display angle α is 180°, and when the information processing apparatus is standing vertically on the desk, the display angle α is 90°. Further, assuming that the rotation angle R is 0° when the imaging unit 120 is on the upper side, it is 90° when the imaging unit 120 is on the left side, 180° when the imaging unit 120 is on the lower side, and 270° when the imaging unit 120 is on the right side.

For example, in the case of “Clamshell,” it is detected at a hinge angle θ of 700 to 135°. Further, in the case of “Portrait,” it is detected at a hinge angle θ of 1600 or more (a maximum of 180°) and a display angle α of 70° to 135°. Further, in the case of “Landscape,” it is detected at a hinge angle θ of 1600 or more (a maximum of 180°) and a display angle α of 70° to 135°. Note that when “Portrait” and “Landscape” are distinguished, they can be distinguished using the rotation angle β. However, if it is only determined whether or not to support the HPD processing, “Portrait” and “Landscape” will not have to be distinguished, and it can be distinguished between “Portrait” in the upside-down state of the usage form (F) and the others. For example, when the rotation angle β is in a range of 130° to 230°, it may be determined to be the usage form (F) to make the HPD processing unsupported, while when the rotation angle β is other than 130° to 230°, the HPD processing may be supported. Further, such a state that the information processing apparatus 1 is placed on the desk with the surface of the display 110 facing up like in the usage form (D) can be determined, for example, by whether or not the display angle α is less than a predetermined value (for example, 20°).

[Hardware Configuration of Information Processing Apparatus]

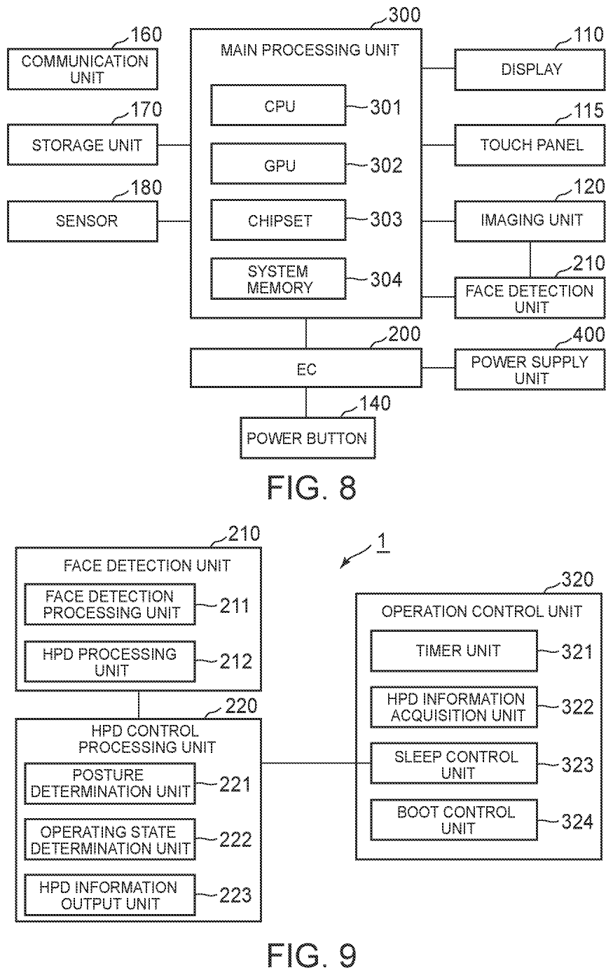

FIG. 8 is a schematic block diagram illustrating an example of the hardware configuration of the information processing apparatus 1 according to one or more embodiments. In FIG. 8, components corresponding to respective units in FIG. 1 are given the same reference numerals. The information processing apparatus 1 is configured to include the display 110, a touch panel 115, the imaging unit 120, a power button 140, a communication unit 160, a storage unit 170, a sensor 180, an EC (Embedded Controller) 200, a face detection unit 210, a main processing unit 300, and a power supply unit 400.

The display 110 displays display data (images) generated based on system processing executed by the main processing unit 300, processing of an application program running on the system processing, and the like. As described with reference to FIG. 1, the display 110 is, for example, the flexible display bendable (foldable) to fit the hinge angle θ by relative rotation of the first chassis 101 and the second chassis 102.

The touch panel 115 is provided on the display screen of the display 110 to output operation signals based on user's touch operations. For example, the touch panel 115 can be any touch panel such as capacitance-type or resistive-film type.

The imaging unit 120 captures an image of an object within the predetermined imaging range (angle of view) in the direction (frontward) to face the inner surface of the first chassis 101, and outputs the captured image to the main processing unit 300 and the face detection unit 210. For example, the imaging unit 120 is a visible light camera (RGB camera) to capture an image using visible light. Note that the imaging unit 120 may also include an infrared camera (IR camera) to capture an image using infrared light, or may be a hybrid camera capable of capturing images using visible light and infrared light. The power button 140 outputs, to the EC 200, an operation signal according to a user's operation.

The communication unit 160 is connected to other devices communicably through a wireless or wired communication network to transmit and receive various data. For example, the communication unit 160 is configured to include a wired LAN interface such as Ethernet (registered trademark), a wireless LAN interface such as Wi-Fi (registered trademark), and the like.

The storage unit 170 is configured to include storage media, such as an HDD (Hard Disk Drive) or an SDD (Solid State Drive), a RAM, and a ROM. The storage unit 170 stores the OS, device drivers, various programs such as applications, and various data acquired by the operation of the programs.

The sensor 180 is a sensor for detecting the movement, orientation, and the like of the information processing apparatus 1. For example, the sensor 180 is used to detect the posture, shaking, and the like of the information processing apparatus 1. For example, the sensor 180 is configured to include an acceleration sensor. Specifically, the sensor 180 has two or more acceleration sensors provided in the first chassis 101 and the second chassis 102, respectively. The sensor 180 detects the respective movements, orientations, and the like of the first chassis 101 and the second chassis 102. Thus, based on the respective movements, orientations, and the like of the first chassis 101 and the second chassis 102, the hinge angle θ, the display angle α, and the rotation angle β described above can be detected. Note that the sensor 180 may also be configured to include an angular velocity sensor, a tilt sensor, a geomagnetic sensor, or the like instead of or in addition to the acceleration sensors.

The power supply unit 400 supplies power to each unit according to the operating state of each unit of the information processing apparatus 1. The power supply unit 400 includes a DC (Direct Current)/DC converter. The DC/DC converter converts the voltage of DC power, supplied from an AC (Alternate Current)/DC adapter or a battery (battery pack) to a voltage required for each unit. The power with the voltage converted by the DC/DC converter is supplied to each unit through each power system. For example, the power supply unit 400 supplies power to each unit through each power system based on a control signal input from the EC 200.

The EC 200 is a microcomputer configured to include a CPU (Central Processing Unit), a RAM (Random Access Memory), a ROM (Read Only Memory), an I/O (Input/Output) logic circuit, and the like. The CPU of the EC 200 reads a control program (firmware) prestored in the own ROM, and executes the read control program to fulfill the function. The EC 200 operates independently of the main system processing unit 300 to control the operation of the main processing unit 300 and manage the operating state of the main processing unit 300. Further, the EC 200 is connected to the power button 140, the power supply unit 400, and the like.

For example, the EC 200 communicates with the power supply unit 400 to acquire information on a battery state (remaining battery capacity, and the like) from the power supply unit 400 and to output, to the power supply unit 400, a control signal or the like in order to control the supply of power according to the operating state of each unit of the information processing apparatus 1.

The face detection unit 210 is configured to include a processor for processing image data of a captured image captured by the imaging unit 120. The face detection unit 210 acquires the image data of the captured image captured by the imaging unit 120, and temporarily stores the acquired image data in a memory. The memory in which the image data is stored may be a system memory 304, or a memory connected to the above processor included in the face detection unit 210.

Further, the face detection unit 210 processes the image data of the captured image acquired from the imaging unit 120 to perform face detection processing for detecting a face area from the captured image. For example, based on the detection result by the face detection processing, the face detection unit 210 executes HPD processing to detect whether or not the user is present in front of the information processing apparatus 1.

The main processing unit 300 is configured to include a CPU (Central Processing Unit) 301, a GPU (Graphic Processing Unit) 302, a chipset 303, and the system memory 304, where processing of various application programs is executable on the OS (Operating System) by system processing based on the OS.

The CPU 301 executes processing based on a BIOS program, processing based on the OS program, processing based on application programs running on the OS, and the like. The CPU 301 controls the operating state of the system under the control of the chipset 303. For example, the CPU 301 executes boot processing to cause the operating state of the system to make the transition from the standby state to the normal operating state. Further, the CPU 301 executes processing to cause the operating state of the system to make the transition from the normal operating state to the standby state.

The GPU 302 is connected to the display 110. The GPU 302 executes image processing under the control of the CPU 301 to generate display data. The GPU 302 outputs the generated display data to the display 110.

The chipset 303 has a function as a memory controller, a function as an I/O controller, and the like. For example, the chipset 303 controls reading data from and writing data to the system memory 304, the storage unit 170, and the like by the CPU 301 and the GPU 302. Further, the chipset 303 controls input/output of data from the communication unit 160, the sensor 180, the display 110, and the EC 200.

Further, the chipset 303 has a function as a sensor hub. For example, the chipset 303 acquires output of the sensor 180 to detect the posture of the information processing apparatus 1 (for example, the hinge angle θ, the display angle α, the rotation angle β, and the like). Then, based on the detected posture of the information processing apparatus 1 and the result of the HPD processing by the face detection unit 210, the chipset 303 executes HPD control processing to instruct the control of the operating state of the system.

The system memory 304 is used as a reading area of a program executed by the CPU 301 and a working area to write processed data. Further, the system memory 304 temporarily stores image data of a captured image captured by the imaging unit 120.

Note that the CPU 301, the GPU 302, and the chipset 303 may also be integrated as one processor, or some or all of them may be configured as individual processors. For example, in the normal operating state, the CPU 301, the GPU 302, and the chipset 303 are all working, but in the standby state, only at least part of the chipset 303 is working. In the standby state, at least only functions required for HPD processing upon booting are working.

[Functional Configuration of Information Processing Apparatus]

Next, a functional configuration in which the information processing apparatus 1 controls the operating state of the system by the HPD processing will be described.

FIG. 9 is a block diagram illustrating an example of the functional configuration of the information processing apparatus 1 according to one or more embodiments. The information processing apparatus 1 includes the face detection unit 210, an HPD control processing unit 220, and an operation control unit 320. The face detection unit 210 corresponds to the face detection unit 210 illustrated in FIG. 8. The HPD control processing unit 220 is a functional component implemented by the main processing unit 300 illustrated in FIG. 8 executing a control program, which is, for example, a functional component executed by the chipset 303. The operation control unit 320 is a functional component implemented by the main processing unit 300 illustrated in FIG. 8 executing the OS program, which is, for example, a functional component executed by the CPU 301.

The face detection unit 210 includes a face detection processing unit 211 and an HPD processing unit 212. The face detection processing unit 211 reads, from the system memory 304, image data of captured images captured by the imaging unit 120 at predetermined time intervals to perform image processing, image analysis, and the like on the respective captured images captured at the predetermined time intervals.

For example, the face detection processing unit 211 detects a face area from each of the captured images respectively captured at the predetermined time intervals. As the face detection method, the face detection unit 210 can apply any detection method using a face detection algorithm for detecting a face based on facial feature information, trained data (learned model) subjected to machine learning based on the facial feature information, a face detection library, or the like. Further, the predetermined time interval can be set, for example, to 15 seconds, 10 seconds, or the like, but the predetermined time interval can also be set to any other time interval. Note that when the predetermined time interval is the shortest time interval, the face is detected in every consecutive frame. The face detection processing unit 211 detects a face area from each of the captured images, respectively, and outputs coordinate information and the like of the detected face area.

The HPD processing unit 212 determines whether or not the user is present in front of the information processing apparatus 1 based on whether or not the face area is detected from the captured image by the face detection processing unit 211. For example, when the face area is detected from the captured image by the face detection processing unit 211, the HPD processing unit 212 determines that the user is present in front of the information processing apparatus 1. On the other hand, when no face area is detected from the captured image by the face detection processing unit 211, the HPD processing unit 212 determines that the user is not present in front of the information processing apparatus 1. Then, the HPD processing unit 212 outputs HPD information based on the determination result of whether or not the user is present in front of the information processing apparatus 1.

For example, when determining that the user is present in front of the information processing apparatus 1, the HPD processing unit 212 outputs HPD information indicating that the HPD determination result is true (hereinafter called Presence information). Further, when determining that the user is not present in front of the information processing apparatus 1, the HPD processing unit 212 outputs HPD information indicating that the HPD determination result is false (hereinafter called Absence information). In other words, the HPD processing unit 212 outputs, to the HPD control processing unit 220, the Presence information or the Absence information based on the detection result of the face area by the face detection processing unit 211.

The HPD control processing unit 220 executes HPD control processing to instruct the control of the operating state of the system based on the posture of the information processing apparatus 1 and the result of the HPD processing by the face detection unit 210. For example, the HPD control processing unit 220 includes a posture determination unit 221, an operating state determination unit 222, and an HPD information output unit 223. The posture determination unit 221 detects the posture of the information processing apparatus 1 based on the output of the sensor 180. For example, as the posture of the information processing apparatus 1, the posture determination unit 221 detects a posture based on the hinge angle θ, the display angle α, the rotation angle β, and the like.

The operating state determination unit 222 determines the operating state of the system controlled by the main processing unit 330. For example, the operating state determination unit 222 determines whether the operating state of the system operating state is the normal operating state or the standby state.

Based on the posture of the information processing apparatus 1 detected by the posture determination unit 221, the operating state of the system determined by the operating state determination unit 222, and the result of the HPD processing by the face detection unit 210, the HPD information output unit 223 outputs, to the operation control unit 320, HPD control information to instruct the control of the operating state of the system.

For example, based on the posture of the information processing apparatus 1 detected by the posture determination unit 221, the HPD information output unit 223 determines whether or not to support the HPD processing. As an example, when the usage form of the information processing apparatus 1 corresponds to any one of the usage forms (A), (B), and (C) in FIG. 7 based on the posture of the information processing apparatus 1 detected by the posture determination unit 221, the HPD information output unit 223 determines to support the HPD processing. On the other hand, when the usage form of the information processing apparatus 1 corresponds to any one of the usage forms (D), (E), (F), and (G) in FIG. 7 based on the posture of the information processing apparatus 1 detected by the posture determination unit 221, the HPD information output unit 223 determines not to support (to unsupport) the HPD processing.

When determining to support the HPD processing, the HPD information output unit 223 sets the HPD processing to a face detection enabled mode to enable the control of the operating state of the system by the HPD processing. On the other hand, when determining not to support (to unsupport) the HPD processing, the HPD information output unit 223 sets the HPD processing to a face detection disabled mode to disable the control of the operating state of the system by the HPD processing.

In the face detection enabled mode, when acquiring the Presence information from the face detection unit 210, the HPD information output unit 223 outputs, to the main processing unit 300, the Presence information as the HPD control information, while when acquiring the Absence information from the face detection unit 210, the HPD information output unit 223 outputs, to the main processing unit 300, the Absence information as the HPD control information. In other words, in the face detection enabled mode, when a face area is detected from a captured image by the face detection unit 210, the HPD information output unit 223 outputs the Presence information, while when no face area is detected, the HPD information output unit 223 outputs the Absence information.

On the other hand, in the face detection disabled mode, the HPD information output unit 223 outputs, to the main processing unit 300, either one of the Presence information and the Absence information regardless of the output of the HPD information from the face detection unit 210. In other words, in the face detection disabled mode, the HPD information output unit 223 outputs, to the main processing unit 300, either one of the Presence information and the Absence information regardless of the detection of a face area from a captured image.

For example, in the face detection disabled mode, the HPD information output unit 223 fixes the HPD control information to be output to the main processing unit 300 to the Presence information in the normal operating state, and fixes the HPD control information to the Absence information in the standby state. Note that processing in this face detection disabled mode may be performed in at least either one of the normal operating state and the standby state.

The operation control unit 320 switches the operating state of the system. For example, the operation control unit 320 executes the boot processing to cause the system to make the transition from the standby state to the normal operating state, and sleep processing to cause the system to make the transition from the normal operating state to the standby state. For example, the operation control unit 320 includes a timer unit 321, an HPD information acquisition unit 322, a sleep control unit 323, and a boot control unit 324.

The timer unit 321 is configured to include a timer to measure an elapsed time from the last operation input in the normal operating state. The timer of the timer unit 321 is reset each time operation input by the user is detected. The operation input by the user is, for example, user's operation input on the touch panel 115.

The HPD information acquisition unit 322 acquires HPD control information output from the HPD control processing unit 220 (the HPD information output unit 223). For example, the HPD information acquisition unit 322 acquires the Presence information or the Absence information from the HPD control processing unit 220 in the normal operating state or the standby state.

The sleep control unit 323 executes sleep processing to cause the system to make the transition from the normal operating state to the standby state. For example, while acquiring the Presence information from the HPD control processing unit 220 in the normal operating state, the sleep control unit 323 causes the system to make the transition from the normal operating state to the standby state under the condition that there is no operation input by the user as the OS function for a certain period of time. For example, when there is an operation on the touch panel 115 based on the presence or absence of an operation signal output from the touch panel 115, the sleep control unit 323 resets the timer of the timer unit 321. Then, the sleep control unit 323 determines whether or not the elapsed time measured by the timer unit 321 reaches a preset sleep time, and when it reaches the sleep time, the sleep control unit 323 determines that there is no operation input by the user for the certain period of time to cause the system to make the transition from the normal operating state to the standby state. The sleep time is set, for example, to five minutes. Note that the sleep time can also be set to any other time by the user.

On the other hand, when acquiring the Absence information from the HPD control processing unit 220 in the normal operating state, the sleep control unit 323 determines that the user has left the information processing apparatus 1 (Leave), and causes the system to make the transition from the normal operating state to the standby state. In other words, when the Absence information is acquired by the HPD information acquisition unit 322, the sleep control unit 323 causes the system to make the transition from the normal operating state to the standby state without waiting for the certain amount of time in which there is no operation input by the user.

Note that when the HPD information acquisition unit 322 acquires the Absence information in the normal operating state, the sleep control unit 323 may also cause the system to make the transition from the normal operating state to the standby state under the condition that HPD information acquisition unit 322 acquires the Absence information continuously for a certain amount of time (for example, 30 seconds). In other words, even when the HPD information acquisition unit 322 acquires the Absence information in the normal operating state, if the HPD information acquisition unit 322 acquires the Presence information before the certain amount of time elapses, the sleep control unit 323 may continue the normal operating state. Thus, since the normal operating state is continued in such a situation that the user leaves for a short time and then returns soon, the information processing apparatus 1 does not make the transition to the standby state despite no user's intention to suspend the use of the information processing apparatus 1, and this is convenient.

The boot control unit 324 executes the boot processing to cause the system to make the transition from the standby state to the normal operating state. For example, when acquiring the Presence information from the HPD control processing unit 220 in the standby state, the boot control unit 324 determines that a person approaches the information processing apparatus 1 (Approach), and causes the system to make the transition from the standby state to the normal operating state.

On the other hand, the boot control unit 324 maintains the standby state while acquiring the Absence information from the HPD control processing unit 220 in the standby state.

[Operation of HPD Control Processing in Normal Operating State]

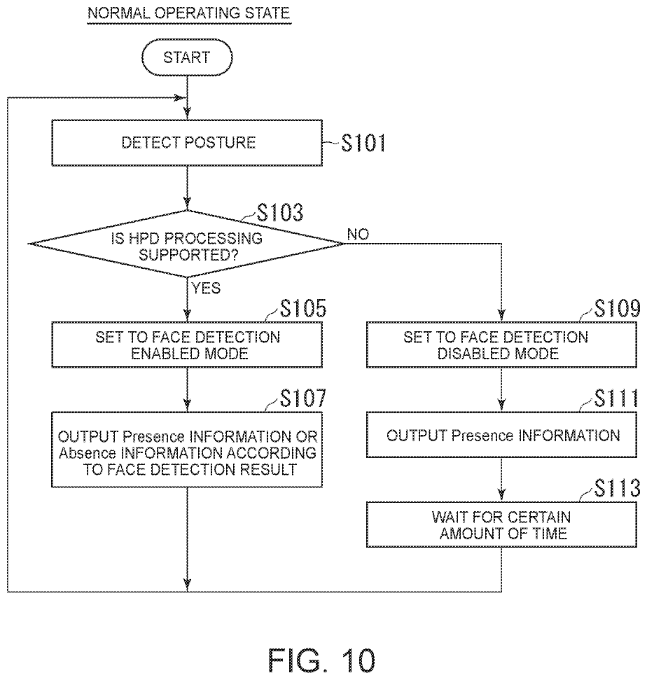

Referring next to FIG. 10, the operation of HPD control processing in which the HPD control processing unit 220 switches between the face detection enabled mode and the face detection disabled mode in the normal operating state to output HPD control information will be described.

FIG. 10 is a flowchart illustrating an example of HPD control processing in the normal operating state according to one or more embodiments.

(Step S101) The HPD control processing unit 220 detects the posture of the information processing apparatus 1 based on the output of the sensor 180. For example, the HPD control processing unit 220 detects, as the posture of the information processing apparatus 1, a posture based on the hinge angle θ, the display angle α, the rotation angle β, and the like. Then, the procedure proceeds to a process in step S103.

(Step S103) The HPD control processing unit 220 determines whether or not to support the HPD processing based on the posture of the information processing apparatus 1 detected in step S101. When determining to support the HPD processing (YES), the HPD control processing unit 220 proceeds to step S105. On the other hand, when determining not to support (to unsupport) the HPD processing (NO), the HPD control processing unit 220 proceeds to a process in step S109.

(Step S105) The HPD control processing unit 220 sets the HPD processing to the face detection enabled mode, and proceeds to a process in step S107.

(Step S107) In the face detection enabled mode, the HPD control processing unit 220 outputs, to the main processing unit 300, the Presence information or the Absence information according to the detection result of the face area by the face detection unit 210. Specifically, when acquiring the Presence information from the face detection unit 210, the HPD control processing unit 220 outputs the Presence information to the main processing unit 300, while when acquiring the Absence information, the HPD control processing unit 220 outputs the Absence information to the main processing unit 300. Then, the procedure returns to the process in step S101 to repeat the HPD control processing.

(Step S109) The HPD control processing unit 220 sets the HPD processing to the face detection disabled mode, and proceeds to a process in step S111.

(Step S111) In the face detection disabled mode, the HPD control processing unit 220 outputs the Presence information to the main processing unit 300. In other words, the HPD control processing unit 220 fixes the HPD control information to be output to the main processing unit 300 to the Presence information in the face detection disabled mode. Then, the procedure proceeds to a process in step S113.

(Step S113) The HPD control processing unit 220 waits for a certain amount of time (for example, one second), and then returns to the process in step S101 to repeat the HPD control processing. In the face detection disabled mode, since the face detection processing result is not reflected in the HPD control processing, the cycle of the HPD control processing is lengthened more than that in the face detection enabled mode. Thus, power consumption can be reduced. Note that the detection frame rate in the face detection disabled mode may be set lower than that in the face detection enabled mode.

[Operation of Sleep Processing in Normal Operating State]

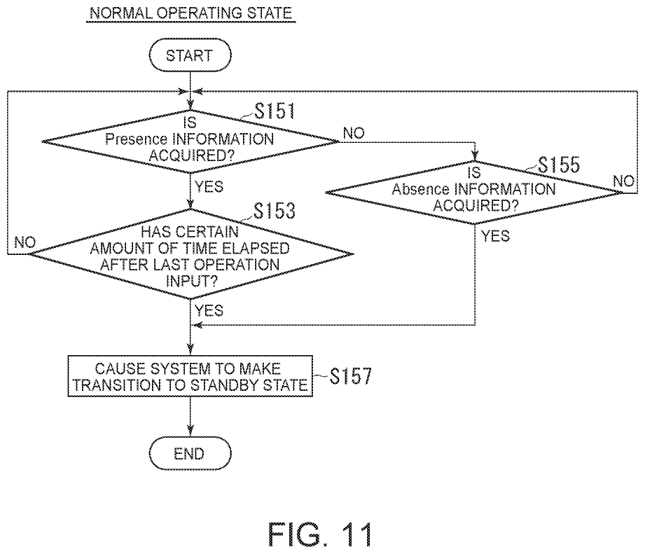

Referring next to FIG. 11, the operation of sleep processing executed by the operation control unit 320 in the normal operating state will be described. FIG. 11 is a flowchart illustrating an example of sleep processing according to one or more embodiments.

(Step S151) The operation control unit 320 determines whether or not the Presence information is acquired from the HPD control processing unit 220. When determining that the Presence information is acquired (YES), the operation control unit 320 proceeds to a process in step S153. On the other hand, when determining that the Presence information is not acquired (NO), the operation control unit 320 proceeds to a process in step S155.

(Step S153) The operation control unit 320 determines whether or not a certain amount of time has elapsed after the last user's operation input while acquiring the Presence information. For example, the operation control unit 320 determines whether or not the elapsed time after the last user's operation input reaches the preset sleep time (for example, five minutes) to determine whether or not the certain amount of time has elapsed after the last user's operation input. When determining that the certain amount of time has not elapsed after the last user's operation input (NO)), the operation control unit 320 returns to the process in step S151. On the other hand, when determining that the certain amount of time has elapsed after the last user's operation input (YES), the operation control unit 320 determines that there is no user's operation input for the certain amount of time, and causes the system to make the transition from the normal operating state to the standby state (step S157).

(Step S155) The operation control unit 320 determines whether or not the Absence information is acquired from the HPD control processing unit 220. When determining that the Absence information is not acquired (NO)), the operation control unit 320 returns to the process in step S151. On the other hand, when determining that the Absence information is acquired (YES), the operation control unit 320 determines that the user has left the information processing apparatus 1 (Leave), and causes the system to make the transition from the normal operating state to the standby state (step S157).

Note that when the Absence information is acquired continuously for a predetermined time (for example, 30 seconds) from the HPD control processing unit 220 in step S155, the operation control unit 320 may proceed to a process in step S157 to cause the system to make the transition from the normal operating state to the standby state.

[Operation of HPD Control Processing in Standby State]

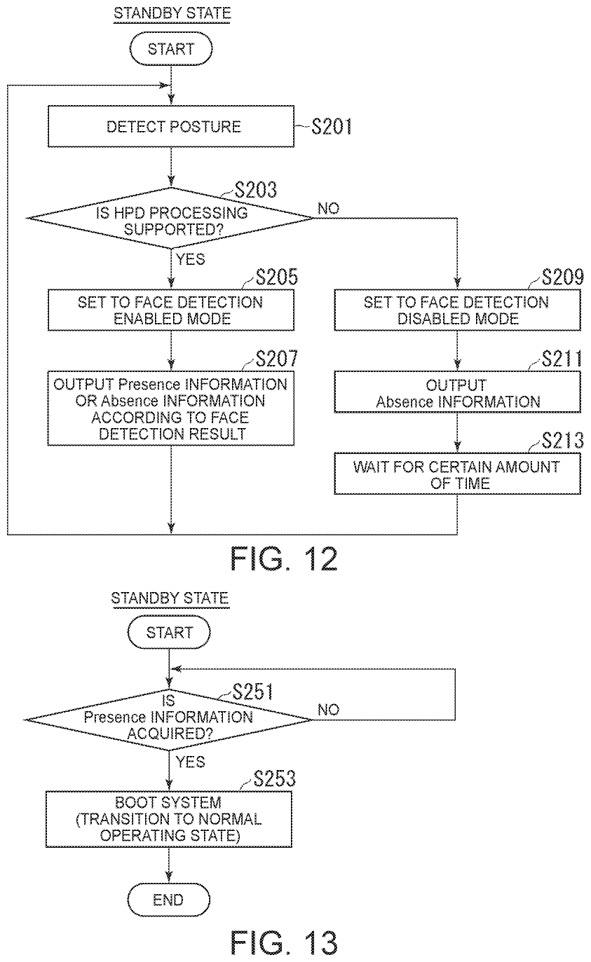

Referring next to FIG. 12, the operation of HPD control processing in which the HPD control processing unit 220 switches between the face detection enabled mode and the face detection disabled mode in the standby state to output HPD control information will be described.

FIG. 12 is a flowchart illustrating an example of HPD control processing in the standby state according to one or more embodiments. Since respective processes in steps S201, S203, S205, S207, S209, and S213 of FIG. 12 are the same as respective processes in steps S101, S103, S105, S107, S109, and S113 of FIG. 10, the description thereof will be omitted. In this processing illustrated in FIG. 12, only a process in step S211 is different from the process in FIG. 10.

(Step S211) In the face detection disabled mode in the standby state, the HPD control processing unit 220 outputs the Absence information to the main processing unit 300. In other words, in the face detection disabled mode in the standby state, the HPD control processing unit 220 fixes the HPD control information to be output to the main processing unit 300 to the Absence information. Then, the procedure proceeds to the process in step S213.

[Operation of Boot Processing in Standby State]

Referring next to FIG. 13, the operation of boot processing executed by the operation control unit 320 in the standby state will be described. FIG. 13 is a flowchart illustrating an example of boot processing according to one or more embodiments.

(Step S251) The operation control unit 320 determines whether or not the Presence information is acquired from the HPD control processing unit 220. When determining that the Presence information is acquired (YES), the operation control unit 320 proceeds to a process in step S253. On the other hand, when determining that the Presence information is not acquired (NO), the operation control unit 320 returns to the process in step S251. For example, the operation control unit 320 returns to the process in step S251 and maintains the standby state while acquiring the Absence information from the HPD control processing unit 220.

(Step S253) The operation control unit 320 determines that a person has approached the information processing apparatus 1 (Approach), and boots the system to make the transition from the standby state to the normal operating state.

### SUMMARY OF ONE OR MORE EMBODIMENTS

As described above, the information processing apparatus 1 according to one or more embodiments includes: the foldable display 110; the imaging unit 120 which captures a direction to face at least part of the display surface of the display; the sensor 180 for detecting the posture of the information processing apparatus 1; the system memory 304 (an example of a memory) which temporarily stores a program of the OS (an example of a system); the CPU 301 (an example of a first processor); the face detection unit 210 (an example of a second processor); and the chipset 303 (an example of a third processor). The CPU 301 executes the program of the OS stored in the system memory 304 to control the operation of the system. The face detection unit 210 detects a face area with a face captured therein from an image captured by the imaging unit 120. The chipset 303 executes a face detection enabled mode (an example of first processing) and a face detection disabled mode (an example of second processing) while switching, based on the posture of the information processing apparatus 1 detected using the sensor 180, between the face detection enabled mode to output Presence information (an example of first information) when the face area is detected by the face detection unit 210, or output Absence information (an example of second information) when the face area is not detected, and the face detection disabled mode to output either one of the Presence information and the Absence information regardless of the detection of the face area by the face detection unit 210. Then, the CPU 301 controls the operation of the system based on the face detection enabled mode and the face detection disabled mode switched therebetween and executed by the chipset 303.

Thus, upon controlling the operating state using face detection, since the information processing apparatus 1 switches to the face detection disabled mode when there is a high possibility that face detection cannot be performed correctly depending on the posture of the information processing apparatus 1, malfunction by false detection can be suppressed. Therefore, the information processing apparatus 1 can control the operating state properly depending on the usage.

For example, the CPU 301 switches between the normal operating state (an example of a first operating state) in which the program of the OS is executed and the system is booted and working, and the standby state (an example of a second operating state) in which at least part of the operation of the system is limited compared to the normal operating state. When executing the face detection disabled mode, the chipset 303 outputs the Presence information regardless of the detection of the face area by the face detection unit 210 in the normal operating state, and outputs the Absence information regardless of the detection of the face area by the face detection unit 210 in the standby state.

Thus, in the normal operating state, when there is a high possibility that face detection cannot be performed correctly depending on the posture of the information processing apparatus 1, the information processing apparatus 1 can prevent the transition to the standby state by false detection.

Further, in the normal operating state, the CPU 301 makes the transition to the standby state under the condition that there is no operation input by the user for a certain amount of time, and when acquiring the Absence information output from the chipset 303, the CPU 301 makes the transition to the standby state without waiting for the certain amount of time.

Thus, since the information processing apparatus 1 can execute the face detection enabled mode and the face detection disabled mode while switching between the face detection enabled mode to cause the system to make the transition to the standby state according to the face detection, and the face detection disabled mode to cause the system to make the transition to the standby state when there is no operation input by the user for the certain amount of time regardless of the face detection, the operating state can be controlled properly depending on the usage.

Further, when acquiring the Presence information output from the chipset 303 in the standby state, the CPU 301 makes the transition to the normal operating state, and maintains the standby state while acquiring the Absence information output from the chipset 303.

Thus, when there is a high possibility that face detection cannot be performed correctly depending on the posture of the information processing apparatus 1 in the standby state, the information processing apparatus 1 can suppress booting by false detection.

Further, for example, the chipset 303 detects the posture of the information processing apparatus 1 using the sensor 180 based on the folding angle (for example, the hinge angle θ) of the display 110.

Thus, the information processing apparatus 1 can detect the posture of the information processing apparatus 1 properly, and can switch between the face detection enabled mode and the face detection disabled mode depending on the posture of the information processing apparatus 1.

Further, for example, the chipset 303 detects the posture of the information processing apparatus 1 using the sensor 180 based on the rotation angle (for example, the rotation angle β) using the axis orthogonal to the display surface of the display 110 as the axis of rotation.

Thus, the information processing apparatus 1 can detect the posture of the information processing apparatus 1 properly, and can switch between the face detection enabled mode and the face detection disabled mode depending on the posture of the information processing apparatus 1.

Further, for example, the chipset 303 detects the posture of the information processing apparatus 1 using the sensor 180 based on the angle of the display surface of the display 110 with respect to the horizontal plane (for example, the display angle α).

Thus, the information processing apparatus 1 can detect the posture of the information processing apparatus 1 properly, and can switch between the face detection enabled mode and the face detection disabled mode depending on the posture of the information processing apparatus 1.

Further, a control method for the information processing apparatus 1 according to one or more embodiments including: a step of causing the CPU 301 to execute the program of the OS stored in the system memory 304 in order to control the operation of the system; a step of causing the face detection unit 210 to detect a face area with a face captured therein from an image captured by the imaging unit 120; and a step of causing the chipset 303 to execute the face detection enabled mode (the example of the first processing) and the face detection disabled mode (the example of the second processing) while switching, based on the posture of the information processing apparatus 1 detected using the sensor 180, between the face detection enabled mode to output the Presence information (the example of the first information) when the face area is detected by the face detection unit 210, or output the Absence information (the example of the second information) when the face area is not detected, and the face detection disabled mode to output either one of the Presence information and the Absence information regardless of the detection of the face area by the face detection unit 210, wherein upon controlling the operation of the system, the CPU 301 controls the operation of the system based on the face detection enabled mode and face detection disabled mode switched therebetween and executed by the chipset 303.

Thus, upon controlling the operating state using face detection, when there is a high possibility that face detection cannot be performed correctly depending on the posture of the information processing apparatus 1, since the information processing apparatus 1 switches to the face detection disabled mode, malfunction by false detection can be suppressed. Therefore, the information processing apparatus 1 can control the operating state properly depending on the usage.

While the one or more embodiments of this invention has been described in detail above with reference to the accompanying drawings, the specific configurations are not limited to the above-described one or more embodiments, and design changes are included without departing from the scope of this invention. For example, the respective configurations in the one or more embodiments described above can be combined arbitrarily.

Further, in the aforementioned one or more embodiments, both the HPD control processing in the normal operating state and the HPD control processing in the standby state are described, but the HPD control processing may also be in either one of the operating states. For example, in the face detection disabled mode (the example of the second processing), the configuration may be such that the Presence information is output regardless of the detection of the face area by the face detection unit 210, or that the Absence information is output regardless of the detection of the face area by the face detection unit 210.

Note that in the aforementioned one or more embodiments, the face detection unit 210 detects a face area with a face captured therein from a captured image captured by the imaging unit 120, but the face detection unit 210 may further detect whether or not the orientation of the face in the face area is forward to detect the face area with the face facing forward. For example, the face detection unit 210 may detect whether or not the orientation of the face is forward based on the eye position in the face area, or may further detect the line of sight to detect whether or not the orientation of the face is forward based on the line of sight. Then, in the face detection enabled mode (the example of the first processing), when the face area in which the orientation of the face is forward is detected from the captured image captured by the imaging unit 120, the HPD control processing unit 220 may output the Presence information (the example of the first information), and when the face area in which the orientation of the face is forward is not detected (including such a case that no face area is detected), the HPD control processing unit 220 may output the Absence information (the example of the second information). Here, a range assumed that the orientation of the face is forward is preset as a range capable of determining that the user is looking in the direction of the information processing apparatus 1 (that is, the user is using the information processing apparatus 1). In other words, in the face detection enabled mode, the information processing apparatus 1 may control the operating state of the system not only by the presence or absence of the user (the presence or absence of the face area), but also by whether or not the orientation of the face of the user is in a predetermined range. On the other hand, in the face detection disabled mode (the example of the second processing), the information processing apparatus 1 fixes output to either one of the Presence information (the example of the first information) and the Absence information regardless of the detection of the face area and the orientation of the face. Thus, even when the operating state of the system is controlled not only by the presence or absence of the user (the presence or absence of the detected face area) but also by whether or not the direction of the line of sight of the user is in a predetermined range, the configuration in the one or more embodiments described above to switch between and execute the face detection enabled mode and the face detection disabled mode can be applied.

Further, in the aforementioned one or more embodiments, the example in which the face detection unit 210 is provided separately from the EC 200 is given, but some or all of the functions of the face detection unit 210 may be provided in the EC 200, or some or all of the functions of the face detection unit 210 and the EC 200 may be configured as one package. Further, some or all of the functions of the face detection unit 210 may be provided in the main processing unit 300, or some or all of the functions of the face detection unit 210 and some or all of the functions of the main processing unit 300 may be configured as one package. Further, some or all of the functions of the HPD control processing unit 220 may be configured as a functional component of a processing unit (for example, the EC 200) other than the chipset 303.

Note that the information processing apparatus 1 described above has a computer system therein. Then, a program for implementing the function of each component included in the information processing apparatus 1 described above may be recorded on a computer-readable recording medium so that the program recorded on this recording medium is read into the computer system and executed to perform processing in each component included in the information processing apparatus 1 described above. Here, the fact that “the program recorded on the recording medium is read into the computer system and executed” includes installing the program on the computer system. It is assumed that the “computer system” here includes the OS and hardware such as peripheral devices and the like. Further, the “computer system” may also include two or more computers connected through networks including the Internet, WAN, LAN, and a communication line such as a dedicated line. Further, the “computer-readable recording medium” means a storage medium such as a flexible disk, a magneto-optical disk, a portable medium like a flash ROM or a CD-ROM, or a hard disk incorporated in the computer system. The recording medium with the program stored thereon may be a non-transitory recording medium such as the CD-ROM.

Further, a recording medium internally or externally provided to be accessible from a delivery server for delivering the program is included as the recording medium. Note that the program may be divided into plural pieces, downloaded at different timings, respectively, and then united in each component included in the information processing apparatus 1, or delivery servers for delivering respective divided pieces of the program may be different from one another. Further, it is assumed that the “computer-readable recording medium” includes a medium on which the program is held for a given length of time, such as a volatile memory (RAM) inside a computer system as a server or a client when the program is transmitted through a network. The above-mentioned program may also be to implement some of the functions described above. Further, the program may be a so-called differential file (differential program) capable of implementing the above-described functions in combination with a program(s) already recorded in the computer system.

Further, some or all of the functions of the information processing apparatus 1 in the above-described one or more embodiments may be realized as an integrated circuit such as LSI (Large Scale Integration). Each function may be implemented by a processor individually, or some or all of the functions may be integrated as a processor. Further, the method of circuit integration is not limited to LSI, and it may be realized by a dedicated circuit or a general-purpose processor. Further, if integrated circuit technology replacing the LSI appears with the progress of semiconductor technology, an integrated circuit according to the technology may be used.

### DESCRIPTION OF SYMBOLS

1 information processing apparatus
101 first chassis
102 second chassis
103 hinge mechanism
110 display
115 touch panel
120 imaging unit
140 power button
160 communication unit
170 storage unit
180 sensor
200 EC
210 face detection unit
211 face detection processing unit
212 HPD processing unit
220 HPD control processing unit
221 posture determination unit
222 operating state determination unit
223 HPD information output unit
300 main processing unit
301 CPU
302 GPU
303 chipset
304 system memory
320 operation control unit
321 timer unit
322 HPD information acquisition unit
323 sleep control unit
324 boot control unit
400 power supply unit

What is claimed is:

1. An information processing apparatus comprising:
a foldable display;
a camera which captures a direction to face at least part of a display surface of the display;
a sensor for detecting a posture of the information processing apparatus;
a memory which temporarily stores a program of a system;
a first processor which executes the program to control operation of the system;
a second processor which detects a face area with a face captured therein from an image captured by the camera; and
a third processor which executes processing while switching, based on the posture detected using the sensor, between first processing to output first information when the face area is detected by the second processor, or output second information when the face area is not detected, and second processing to output either one of the first information and the second information regardless of detection of the face area by the second processor,
wherein the first processor controls the operation of the system based on the first processing and the second processing switched therebetween and executed by the third processor.

2. An information processing apparatus comprising:
a foldable display;
a camera which captures a direction to face at least part of a display surface of the display;
a sensor for detecting a posture of the information processing apparatus;
a memory which temporarily stores a program of a system;
a first processor which executes the program to control operation of the system;
a second processor which detects a face area with a face captured therein from an image captured by the camera; and
a third processor which executes processing while switching, based on the posture detected using the sensor, between first processing to output first information when the face area is detected by the second processor, or output second information when the face area is not detected, and second processing to output the second information regardless of detection of the face area by the second processor,
wherein the first processor controls the operation of the system based on the first processing and the second processing switched therebetween and executed by the third processor.

3. The information processing apparatus according to claim 2, wherein
the first processor executes the program to switch between a first operating state in which the system is booted and working, and a second operating state in which at least part of the operation of the system is limited compared to the first operating state, and
when executing the second processing, the third processor outputs the second information regardless of the detection of the face area by the second processor in the second operating state.

4. The information processing apparatus according to claim 1, wherein
the first processor executes the program to switch between a first operating state in which the system is booted and working, and a second operating state in which at least part of the operation of the system is limited compared to the first operating state, and
when executing the second processing, the third processor outputs the first information regardless of the detection of the face area by the second processor in the first operating state, and outputs the second information regardless of the detection of the face area by the second processor in the second operating state.

5. The information processing apparatus according to claim 3, wherein in the first operating state, the first processor makes a transition to the second operating state under a condition that there is no operation input by a user for a certain period of time, and when the second information output from the third processor is acquired, the first processor makes the transition to the second operating state without waiting for a certain amount of time.

6. The information processing apparatus according to claim 3, wherein when the first information output from the third processor is acquired in the second operating state, the first processor makes a transition to the first operating state, and while acquiring the second information output from the third processor, the first processor maintains the second operating state.

7. The information processing apparatus according to claim 1, wherein the second processor detects, as the face area, a face area of a face facing forward from an image captured by the camera.

8. The information processing apparatus according to claim 1, wherein the third processor detects the posture using the sensor based on a folding angle of the display.

9. The information processing apparatus according to claim 1, wherein the third processor detects the posture using the sensor based on a rotation angle using an axis orthogonal to the display surface of the display as an axis of rotation.

10. The information processing apparatus according to claim 1, wherein the third processor detects the posture using the sensor based on an angle of the display surface of the display with respect to a horizontal plane.

11. A control method for an information processing apparatus including: a foldable display; a camera which captures a direction to face at least part of a display surface of the display; a sensor for detecting a posture of the information processing apparatus; a memory which temporarily stores a program of a system; a first processor; a second processor; and a third processor, the control method comprising:
a step of causing the first processor to execute the program in order to control operation of the system;
a step of causing the second processor to detect a face area with a face captured therein from an image captured by the camera; and
a step of causing the third processor to execute processing while switching, based on the posture detected using the sensor, between first processing to output first information when the face area is detected by the second processor, or output second information when the face area is not detected, and second processing to output either one of the first information and the second information regardless of detection of the face area by the second processor,
wherein when controlling the operation of the system, the first processor controls the operation of the system based on the first processing and the second processing switched therebetween and executed by the third processor.

12. A control method for an information processing apparatus including: a foldable display; a camera which captures a direction to face at least part of a display surface of the display; a sensor for detecting a posture of the information processing apparatus; a memory which temporarily stores a program of a system; a first processor; a second processor; and a third processor, the control method comprising:
a step of causing the first processor to execute the program in order to control operation of the system;
a step of causing the second processor to detect a face area with a face captured therein from an image captured by the camera; and
a step of causing the third processor to execute processing while switching, based on the posture detected using the sensor, between first processing to output first information when the face area is detected by the second processor, or output second information when the face area is not detected, and second processing to output the second information regardless of detection of the face area by the second processor,
wherein when controlling the operation of the system, the first processor controls the operation of the system based on the first processing and the second processing switched therebetween and executed by the third processor.
